(19) United States
(12) Patent Application Publication
(10) Pub. No.: US 2011/0166735 A1
(43) Pub. Date: Jul. 7, 2011

(54) Method for setting a motor drive unit in a motor vehicle

(76) Inventor: Mario Kustosch, Vaihingen/Enz (DE)

(21) Appl. No.: 13/062,594

(22) PCT Filed: Sep. 1, 2009
(86) PCT No.: PCT/EP09/61237

§ 371 Date: Mar. 7, 2011

(30) Foreign Application Priority Data
Sep. 19, 2008 (DE) 10 2008 042 228.2

(51) Int. Cl. B60K 6/48; G06F 19/00

(52) U.S. Cl. 701/22; 701/99; 180/65.22; 903/903

(57) ABSTRACT

In a method for setting a motor drive device in a motor vehicle having at least two drive units whose torques are separately settable, in order to determine a consumption-optimal torque distribution, the sum of the individual consumption values of the drive units is ascertained for a plurality of differently distributed drive torques, and the optimum consumption value is determined from the sum of the individual consumption values.

### FIELD OF THE INVENTION

The present invention relates to a method for setting a motor drive device in a motor vehicle.

### BACKGROUND OF THE INVENTION

German Patent Application No. DE 10 2004 049 324 A1 describes a method for controlling and regulating vehicle dynamics in motor vehicles having a hybrid drive system that encompasses, as motor drive units, an electric motor and a combustion engine by each of which a drive torque is to be applied. Torque distribution between the electric motor and combustion engine is determined in a multi-step method in which motor parameters and actuation limits, as well as vehicle dynamics functions, are taken into account.

### SUMMARY

An object of the present invention is to distribute the drive torques, in a motor drive device having at least two drive units in a motor vehicle, in consumption-optimal fashion.

According to an example embodiment of the present invention, a motor drive device in a motor vehicle is provided, having at least two separately settable motor drive units. To determine a consumption-optimal torque distribution between the at least two drive units, the sum of the individual consumption values of the drive units is ascertained for a plurality of differently distributed drive torques. The optimum consumption value, with associated torque distribution, is then determined from the sum of the individual consumption values.

With this procedure, the consumption-optimal torque distribution between the drive units for the present driving situation can be determined from a freely selectable number of different operating points for the at least two motor drive units, by defining different operating points having differently distributed drive torques and determining for each torque combination, from the sum of the individual consumption values, a total consumption value. The most favorable total consumption value, with the associated torque distribution between the drive units, can be identified by comparing the total consumption value for the various operating points.

An advantage of this procedure may be seen, inter alia, in the great flexibility of the example method, since a very wide variety of parameters and boundary conditions internal to the vehicle, as well as environmental conditions, can be taken into account. The example method is preferably suitable for online operation, in which the optimum consumption value is determined while the motor vehicle is in operation, taking into account the instantaneous conditions both internal and external to the vehicle.

The example method according to the present invention can be applied to drive devices having different kinds of drive units. Possibilities are, for example, a hybrid drive system having at least two differently constructed motor drive units, these preferably being a combustion engine and at least one electric motor. It is also possible, however, to provide, e.g., a combination of at least two electric motors or even of two combustion engines. It may furthermore be useful to apply the example method according to the present invention to two motor drive units within a combined system made up of three or more drive units, for example to consumption optimization of an electric motor and of a combustion engine, where one or more further electric motors can be additional constituents of the system. It is, however, also possible in principle, in the context of a combined system of more than two motor drive units, to incorporate all the drive units into the method according to the present invention for consumption optimization.

For the case in which two differently embodied motor drive units are to participate in consumption optimization, the consumption values are converted into comparable units. In the case of a hybrid drive system having a combustion engine and an electric motor, for example, it is useful to convert the consumption value of the electric motor into a fuel equivalent, in which the chemical energy of a battery or rechargeable battery powering the electric motor is evaluated using an economy factor dependent on the charge state of the battery or rechargeable battery. This procedure makes it possible to compare the chemical power output of the battery with the power output from the fuel. By way of the economy factor, the chemical energy stored in the battery is evaluated differently as a function of the instantaneous charge state. It may be useful, for example, when a battery is fully charged, to evaluate the energy contained it as favorable and to make it usable for propulsion, so as then to create new storage room for energy recovery phases. In this case, a shift in the torque distribution toward the electric motor will take place as a result of the more positive evaluation of the chemical energy. If the charge state of the battery is low, on the other hand, the chemical energy in the battery can then be evaluated as being comparatively expensive for use as propulsion for the vehicle, since if the charge state fell below a critical value, efficient charging via the combustion engine would be necessary in order to prevent a harmful deep discharge of the battery; in this case the torque distribution is therefore shifted in favor of the combustion engine.

The variables internal to the vehicle that can be taken into account are motor- or engine-specific parameters as well as parameters of the drivetrain. Influences and limitations deriving from vehicle dynamics are also relevant. External influence variables that are considered are ambient conditions, for example the position and speed of preceding vehicles, obstacles on the roadway, or the road layout, which can be determined by way of a corresponding sensor suite such as, for example, a spacing sensing system and navigation systems.

In terms of limitations in the drivetrain, consideration can be given, for example, to maximum transferable drive torques that should not be exceeded, by defining a maximum permissible drive torque at an axle or at all axles. The motor drive units preferably act on different vehicle axles of the motor vehicle; in principle, drive units acting on a single vehicle axle can in principle also be set in consumption-optimal fashion in accordance with the method according to the present invention. For the case in which the drive units act on different axles, it is also possible to define maximum drive torques of different, or optionally also identical, magnitudes at the respective axles or in the drivetrain to the respective axles.

The torque distribution can also be influenced by vehicle dynamics control systems, for example by an electronic stability program (ESP). An intervention by a vehicle dynamics control program results, for example, in a limitation of the torque transferable to one of the motor drive units or to a vehicle axle. This intervention in terms of drive torque can be carried out both for vehicle stabilization (or to prevent vehicle instability) and to improve the vehicle's dynamic behavior, in particular more sporty vehicle behavior, for example by influencing the steering behavior of the vehicle by way of a different torque distribution.

A further relevant vehicle-dynamics influencing variable is consideration of wheel and tire slip values. This can be done by applying a lower drive torque to an axle with higher slip than to the axle with less slip. Also appropriate is a reduction in drive torque in order to reduce drive slip to less than a limit value.

The distribution of drive torques to each drive unit is preferably done between a value of zero and a maximum drive torque value for the relevant drive unit, the zero value being set, by way of example, by way of an interruption in the drivetrain, in particular by opening a coupling member.

Further advantages and example embodiments may be gathered from the description below, and the figures.

### BRIEF DESCRIPTION OF THE DRAWINGS

FIG. 1 schematically depicts a vehicle having a hybrid drive system; a block diagram for the apportionment of drive torques between the combustion engine and the electric motor of the hybrid drive system is additionally shown.

FIG. 2 is a block diagram for evaluating the total consumption value, which is made up of the individual consumption values of the combustion engine and the electric motor.

### DETAILED DESCRIPTION OF EXAMPLE EMBODIMENTS

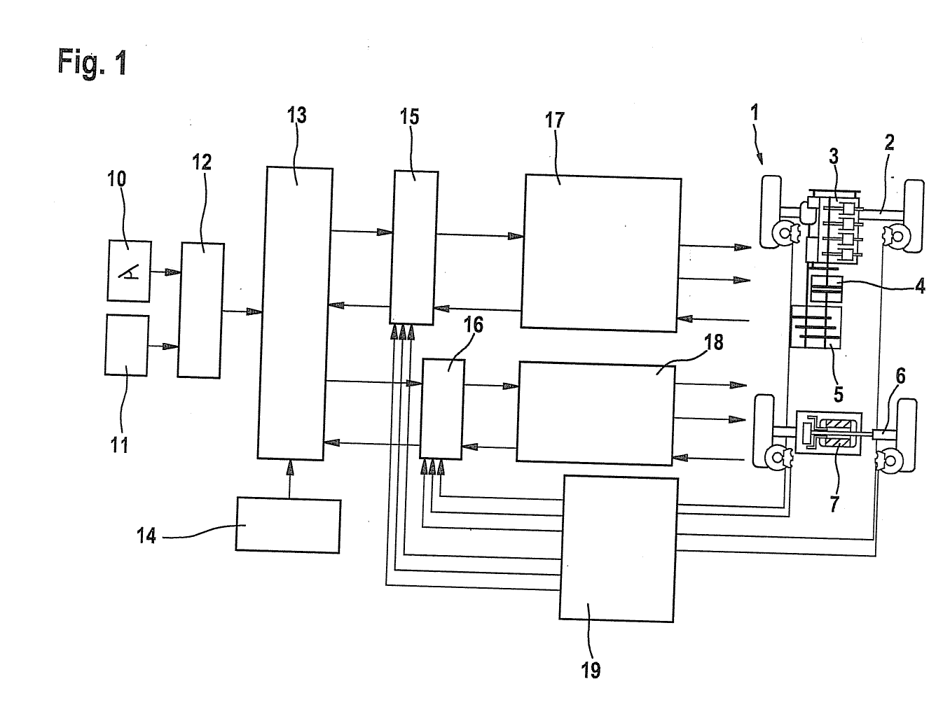

Motor vehicle 1 depicted in FIG. 1 has a hybrid drive system that encompasses a combustion engine 3 as well as an electric motor 7, the drive torques of combustion engine 3 and of electric motor 7 being settable separately from one another. Combustion engine 3 delivers its drive torque, via an adjustable coupling 4 and a gearbox 5, to front axle 2 of the motor vehicle. Electric motor 7 acts on rear axle 6. Further drive units are not shown in the example embodiment shown.

The vehicle is usefully equipped with vehicle control systems. It possesses, in particular, an electronic braking system with vehicle dynamics control (electronic stability program, ESP). The braking torques can be controlled for each individual wheel, and the braking system calculates, from available sensor data, the tire forces to be transferred at the moment for each wheel. The maximum and minimum total transferable torque per axle can be ascertained from the sensor data. The braking system can act on the respective axle drive systems via a respective torque-elevating or torque-lowering intervention, so that vehicle stability can be produced or maintained in the event of driving states that are critical in terms of vehicle dynamics.

The vehicle is provided with a closed- or open-loop control unit, or equipped with various individual closed- or open-loop control units that together form the closed- or open-loop control unit, in which sensor signals of a vehicle-internal sensor suite are processed, and actuating signals for setting the various actuating units in the vehicle are generated.

Shown in the left half of FIG. 1 is a block diagram with blocks 10 to 19 that represent various functionalities by which the vehicle state can be influenced. According to block 10, the driver stipulates a driver-requested torque that, in a subsequent block 12, is coordinated with a speed function that is delivered to block 12 from a block 11; the speed function is, for example, a cruise control function or a separation control system.

Depending on the correlation between the driver-requested torque and the speed function, block 12 ascertains a total drive torque that is delivered as an input signal to the subsequent block 13 in which, together with block 14, a torque distribution is carried out between combustion engine 3 on front axle 2 and electric motor 7 on rear axle 6. The torque distribution between the front and rear axle takes into account a variety of boundary conditions from the drivetrain, including engine-related boundary conditions, as well as limitations that derive from vehicle dynamics control systems, for example an electronic stability program (ESP), and further optimization strategies or cost functions, in particular an optimization of total energy consumption, which is made up of the individual consumption values of the motor drive units of the motor vehicle.

To determine the optimum consumption value with corresponding torque distribution between combustion engine 3 and electric motor 7, an optimization algorithm, in which the respective individual consumption values for a plurality of drive torques differently distributed between the motor drive units are determined, is executed while the motor vehicle is in operation, and the optimum consumption value is ascertained by way of the sum of the individual consumption values. Concretely, this is carried out in such a way that the drive torque of, for example, the electric motor at the rear axle is computationally increased piecewise, starting from a minimum value, and the instantaneous consumption value of the electric motor is determined for each torque value. Because the portion of the torque attributable to the combustion engine is also known (from the difference as compared with the predefined total drive torque), the consumption value of the combustion engine can also be ascertained at each iteration step, so that the individual consumption values for both the electric motor and the combustion engine are known for each computationally considered torque distribution between the electric motor and combustion engine. Once the iteration loop has been executed for a predefined total value range of drive torques of the electric motor in predefined torque steps, and after consideration of the respective torque portion attributable to the combustion engine, the optimum consumption value is determined from the sum of the individual consumption values at each iteration step. The torque distribution between combustion engine and electric motor associated with that optimum combustion is thus also known.

The torque distribution is, however, subject to restrictions arising from the motor drive units, the transfer path in the drivetrain, and the instantaneous vehicle dynamics. Conditions external to the vehicle can also have a limiting effect, for example the road layout, obstacles in the roadway, or the position and behavior of preceding vehicles. Such limitations are incorporated into the calculation of the consumption-optimal torque distribution, in accordance with block 13 or 14, from blocks 15 and 16, in which the various boundary conditions and limitations at the front axle (block 15) and rear axle (block 16) are coordinated. Input variables that are on the one hand the instantaneous, consumption-optimal torque distributions from block 13, and on the other hand vehicle-dynamics state variables and limitations from a block 19 representing an ESP system, are delivered to coordination blocks 15 and 16 and also to blocks 17 and 18, which contain the boundary conditions and limitations of the combustion engine and the transmission train to the front axle (block 17) and of the electric motor and the drivetrain to the rear axle (block 18). If it is determined in coordination block 15 that the calculated, consumption-optimal value of the torque distribution cannot be implemented as a result of currently existing limitations, a corresponding signal then goes back to block 13 and a new calculation is made of the consumption-optimal torque distribution with appropriate consideration of the input variable from coordination block 15.

Once a value for the torque distribution that is consumption-optimal in consideration of the limitations has finally been found, corresponding actuation signals go to combustion engine 3 and to electric motor 7, and if applicable to the respective drivetrain actuation units, to set the respective desired drive torque at the front axle and rear axle.

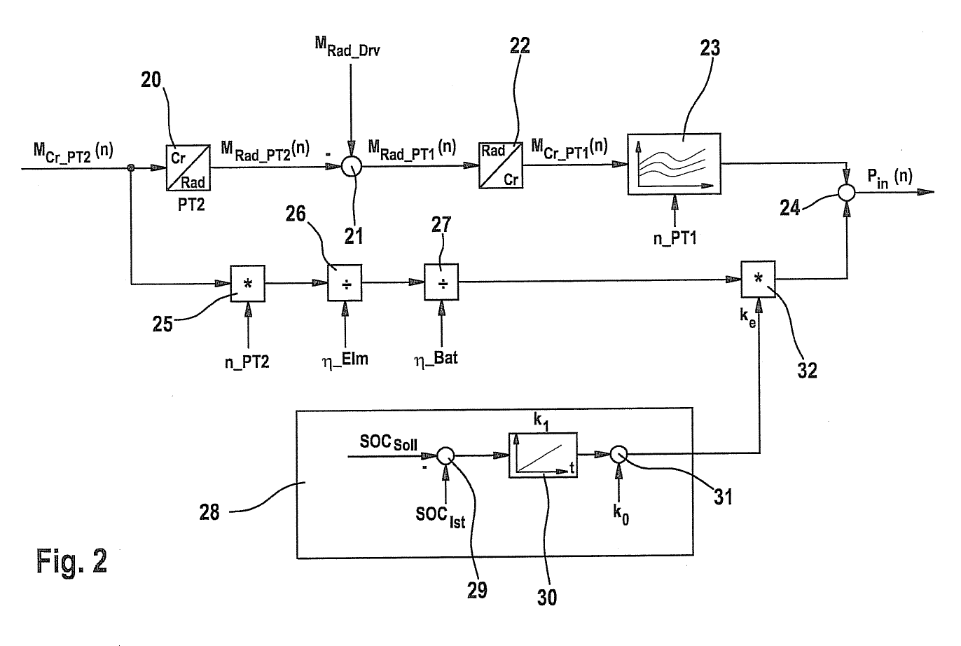

FIG. 2 is a block diagram for evaluation of the instantaneous total consumption value, made up of the individual consumption values of the combustion engine at the front axle and the electric motor at the rear axle. The “Cr” index here denotes the respective crankshaft, “PT1” and “PT2” the drivetrain at the front axle and rear axle, respectively, and “n” the current iteration step for calculating the total consumption value.

First block 20 in the upper branch of the block diagram contains a torque transfer function for converting the crankshaft torque M_{Cr}_{_{—}}_{PT2} at the rear axle into a corresponding wheel drive torque M_{Rad}_{_{—}}_{PT2} at the rear axle. In the upper branch of the block diagram, the rear axle wheel drive torque M_{Rad}_{_{—}}_{PT2}, present at the output of block 20, for the current iteration step n is subtracted, in a block or step 21, from a driver-requested torque M_{Rad}_{_{—}}_{Drv}, which yields the front axle wheel drive torque M_{Rad}_{_{—}}_{PT1} of the current iteration step n. This is converted, in the next block 22 which contains a further torque transfer function, back into a corresponding front axle crankshaft torque M_{Cr}_{_{—}}_{PT1} which is then, in the next block 23 for the instantaneous rotation speed n_PT1 of the combustion engine, converted into a consumption value for the combustion engine.

In the lower branch of the block diagram, the rear axle crankshaft torque M_{Cr}_{_{—}}_{PT2}, which corresponds to the drive torque of the electric motor, is multiplied in block 25 by the instantaneous rotation speed n_PT2 of the electric motor in order to obtain the electrical power output that would need to be withdrawn from the electric motor's battery in order to implement the corresponding drive torque. The further blocks 26 and 27 take into account the efficiencies η_Elm of the electric motor and η_Bat of the battery, which correspondingly decrease the calculated power output value. The value obtained therefrom is then multiplied in a block 32 by an economy factor kₑ from which is obtained a fuel-equivalent electrical power output that is added, in block 24, to the power output from the fuel for the internal combustion engine to yield the total consumption value Pᵢₙ(n) for the current iteration step.

The total consumption value Pᵢₙ is determined for a plurality of iteration steps n, each iteration step n standing for a different value of the drive torque M_{Cr}_{_{—}}_{PT2} of the electric motor and therefore, with consideration of the driver-requested torque M_{Rad}_{_{—}}_{Drv}, for a corresponding torque distribution between the electric motor and combustion engine. From the sum of the total consumption values Pᵢₙ thus obtained, it is then possible to determine the lowest value that can be allocated to a specific torque ratio, which is set by corresponding application of control to the combustion engine and the electric motor at the vehicle's axles.

The economy factor kₑ, which is taken into account in block 32 and allows the chemical power output from the battery to be made comparable with the power output from the fuel, is calculated in block 28. Contained in this block 28 are further blocks 29 to 31 which represent calculation of the economy factor kₑ. The difference between the target charge state SOCₛₒ_{^{ll}} and actual charge state SOCᵢ_{ₛₜ} of the battery is determined in block 29. The difference value passes as an input value to block 30, in which the charge state difference value is integrated with a gain factor kᵢ, an offset k₀ being also added in block 31. The offset k₀ can be assigned, for example, a value of 1, which represents an equalized charge k₀ means that the chemical energy is being evaluated as identical to the energy from the fuel. The integrator in block 30 operates in the manner of a memory, in order to take into account the duration of the system deviation. Once the discharge and charge phases balance one another, the value is equalized. On the other hand, if the discharge phase predominates, for example, then the economy factor kₑ becomes greater, so that the chemical energy from the battery is evaluated as being less favorable for driving the vehicle. Conversely, when the economy factor kₑ is lower, the chemical energy from the battery, and thus actuation of the electric motor, is evaluated more favorably.

1-20. (canceled)

21. A method for setting a motor drive device in a motor vehicle, the motor drive device including at least two drive units, drive torques of the two drive units being separately settable, the method comprising:
ascertaining for a plurality of differently distributed drive torques a sum of individual consumption values of the drive units; and
determining an optimum consumption value with associated torque distribution from the sum of the individual consumption values to determine a consumption-optimum torque distribution between the drive units.

22. The method as recited in claim 21, wherein the drive torques are distributed so that the sum of the drive torques corresponds to a predetermined total drive torque.

23. The method as recited in claim 22, wherein the total drive torque corresponds to a torque request of a driver of the motor vehicle.

24. The method as recited in claim 21, wherein the drive units act on different vehicle axles.

25. The method as recited in claim 21, wherein the determination of the optimum consumption value is carried out while the motor vehicle is in operation.

26. The method as recited in claim 21, wherein motor drive device is a hybrid drive system, and the at least two drive units include a combustion engine and at least one electric motor, and wherein the consumption value of the electric motor is converted into a fuel equivalent.

27. The method as recited in claim 26, wherein in the determination of the fuel equivalent, chemical energy of a battery powering the electric motor is evaluated using an economy factor that depends on a charge state of the battery.

28. The method as recited in claim 21, wherein the motor drive device is a hybrid drive system, and the at least two drive unit includes a combustion engine and at least one electric motor, and wherein power output to be delivered for a specific drive torque is established by way of a fuel supply to the combustion engine.

29. The method as recited in claim 28, wherein the consumption-optimal torque distribution is carried out within at least one of device-specific limits and vehicle-dynamics limits.

30. The method as recited in claim 29, wherein a maximum permissible drive torque at a vehicle axle is predefined.

31. The method as recited in claim 29, wherein a minimum permissible drive torque at a vehicle axle is predefined.

32. The method as recited in claim 29, wherein a charge state of a battery of the electric motor is taken into account in the torque distribution.

33. The method as recited in claim 32, wherein one of torque reductions or torque interruptions in a drivetrain between the combustion engine and a vehicle axle driven by the combustion engine, are taken into account.

34. The method as recited in claim 28, wherein one of unstable driving states or driving states with decreased vehicle stability are taken into account.

35. A control unit for setting a motor drive device in a motor vehicle, the motor drive device including at least two drive units, drive torque of the drive units being separately settable, the control unit configured to ascertain for a plurality of differently distributed drive torques a sum of individual consumption values of the drive units, and to determine an optimum consumption value and associated torque distribution from the sum of the individual consumption values to determine a consumption-optimum torque distribution between the drive units.

36. A motor drive device, comprising:
at least two drive units, drive torques of the drive units being individually settable; and
a control unit configured to ascertain for a plurality of differently distributed drive torques a sum of individual consumption values of the drive units, and to determine an optimum consumption value unit associated torque distribution from the sum of the individual consumption value to determine a consumption-optimal torque distribution between the drive units.

37. The motor drive device as recited in claim 36, wherein the motor drive device is a hybrid drive system, and the drive units of the hybrid drive system includes a combustion engine and at least one electric motor.

38. The motor drive device as recited in claim 37, wherein the combustion engine of the hybrid drive system acts on a first vehicle axle, and at least one electric motor acts on a further vehicle axle.

39. The motor drive device as recited in claim 37, wherein the motor drive device includes at least two electric motors.

40. The motor drive device as recited in claim 37, wherein the motor drive device encompasses at least two combustion engines.
